(19) United States
(12) Patent Application Publication
(10) Pub. No.: US 2006/0104175 A1
(43) Pub. Date: May 18, 2006

(54) Method of selecting recording speed and recorder thereof

(76) Inventors: Pei-Yu Chiu, Taichung City (TW); Ya-Ping Pan, Cigu Township (TW)

Correspondence Address: RABIN & Berdo, PC, 1101 14TH STREET, NW, SUITE 500, WASHINGTON, DC, 20005, US

(21) Appl. No.: 11/260,274

(22) Filed: Oct. 28, 2005

(30) Foreign Application Priority Data
Nov. 15, 2004 (TW) 93134999

(51) Int. Cl. G11B 27/22

(52) U.S. Cl. 369/47.36

(57) ABSTRACT

A recorder including an optical pick up head and a processor can provide a number of recording speeds for recording an optical disc. The optical pick up head is for recording the optical disc while the processor for controlling the optical pick up head to perform an optimum power calibration (OPC) procedure for each recording speed to provide the corresponding recording quality index. A method of selecting recording speed includes placing the optical disc into the recorder; performing the OPC procedure for each recording speed in the recorder to obtain the corresponding recording quality index; and selecting the required recording speed from the supported recording speeds according to the recording quality indexes and records the optical disc according to the selected recording speed.

This application claims the benefit of Taiwan application Serial No. 93134999, filed Nov. 15, 2004, the subject matter of which is incorporated herein by reference.

### BACKGROUND OF THE INVENTION

1. Field of the Invention

The invention relates in general to a method of selecting recording speed and recorder thereof, and more particularly to a method of selecting recording speed in which the optimum recording speed can be selected according to disc recording quality, and recorder thereof.

2. Description of the Related Art

Recorders can generally use a number of supported recording speeds to record optical discs, such as CD or DVD discs. In terms of 16×DVD, the supported recording speeds are 1×, 2×, 4×, 8×, 12×, and 16×, and the recording quality of each disc is related to the recording strategy constructed in the recorder used.

The recording strategy includes laser recording waveform and laser recording power setup. The laser recording waveform corresponding to every supported recording speed is usually built in the recorder or in the optical disc. When the recorder starts to record an optical disc by a certain recording speed, the optimum power calibration (OPC) procedure is performed so as to obtain the optimum recording power. Afterward, the recorder can record the optical disc by this recording speed according to the laser recording waveform built in the recorder or in the optical disc and the obtained optimum recording power.

In terms of one optical disc, the disc recording quality usually differs under different recording speeds. Even a recorder is sold with the default setting that using the highest recording speed provides the optimum disc recording quality since the recording quality of the optical disc is related to the recorder environment temperature, the optical disc quality and the ageing status of the recorder, the recording quality of the same optical disc under each supported recording speed will be unpredictable. Therefore, users cannot know beforehand which recording speed can be used to obtain the optimum recording quality, and thus may fail in recording by using an improper recording speed.

### SUMMARY OF THE INVENTION

It is therefore an object of the invention to provide a method of selecting recording speed and recorder thereof. The OPC procedure is performed in accordance with each recording speed to obtain the disc recording quality related information corresponding to various recording speeds. The required recording speed can be determined directly by the recorder or selected by the user according to the recording quality related information, so the recorder can achieve the optimum or user acceptable recording effect.

The invention achieves the above-identified object by providing a method of selecting recording speed used in a recorder. The recorder provides a number of recording speeds for recording an optical disc. The method includes placing the optical disc into the recorder; performing an optimum power calibration (OPC) procedure for each recording speed in the recorder so as to obtain a corresponding recording quality index; and selecting the required recording speed from the recording speeds according to the recording quality indexes, and recording the optical disc by the selected recording speed to end the recording process.

The invention achieves the above-identified object by providing a recorder capable of providing a number of recording speeds for recording an optical disc. The recorder includes an optical pick up head and a processor. The optical pick up head is for recording the optical disc. The processor is for controlling the optical pick up head to perform an optimum power calibration (OPC) procedure for each recording speed and providing a recording quality index accordingly. The recorder selects the required recording speed from the recording speeds according to the recording quality indexes corresponding to the recording speeds and records the optical disc accordingly.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a recorder according to a preferred embodiment of the invention.

FIG. 2 is a flow chart of the method of selecting recording speed according to a preferred embodiment of the invention.

FIG. 3 is a comparison diagram between the laser powers and the direct current jiggling value (jitter) and the block error rate (bier) generated thereby under a certain recording speed according to a preferred embodiment of the invention.

FIG. 4 shows a table and a bar chart of the relationship among the recording speeds, the corresponding optimum jitters, optimum blers, and recording quality indexes displayed on the display according to a preferred embodiment of the invention.

### DETAILED DESCRIPTION OF THE INVENTION

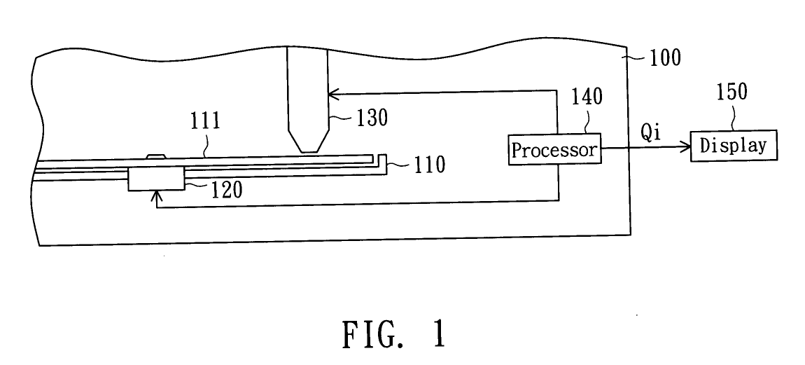

Referring to FIG. 1, a block diagram of a recorder according to a preferred embodiment of the invention is shown. The recorder 100, such as the recorder configured in a computer or in a TV program recording apparatus, includes a disc tray 110, a spindle motor 120, an optical pick up head 130, and a processor 140. The disc tray 110 is for carrying an optical disc, such as a CD, a DVD, or a Blu-ray disc (BD). The spindle motor 120 controlled by the processor 140, is used for rotating the optical disc 111 in accordance with a recording speed. The optical pick up head 130, controlled by the processor 140, is used for recording the optical disc 111. Moreover, the processor 140 actuates the spindle motor 120 to rotate the optical disc 111 at a recording speed and controls the optical pick up head 130 to perform the OPC procedure so as to obtain a disc recording quality index Qi and transmit it to be displayed on the display 150.

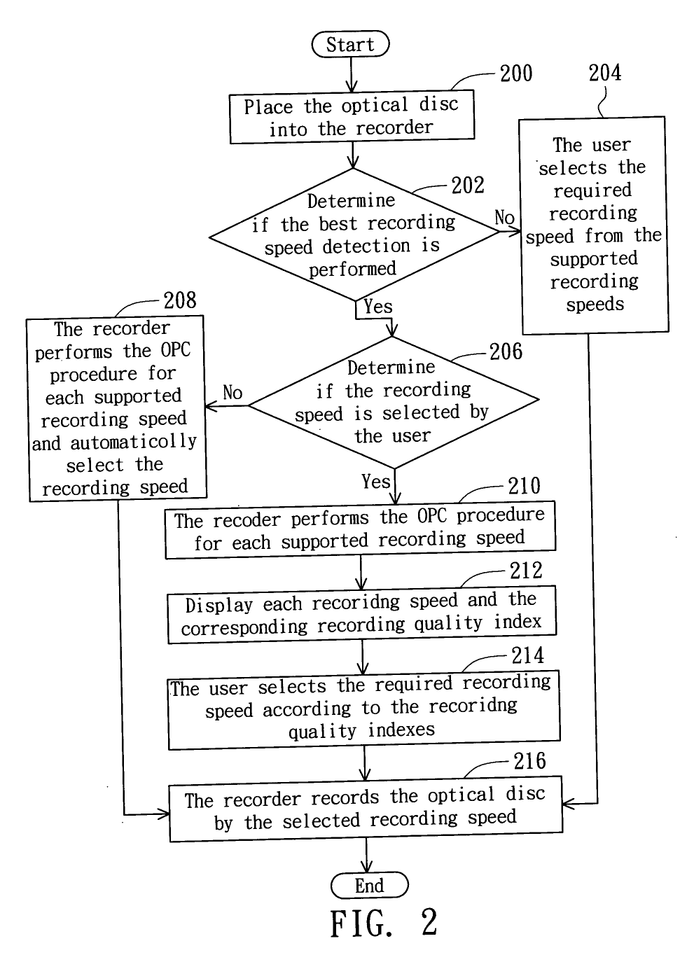

Referring to FIG. 2, a flow chart of the method of selecting recording speed according to a preferred embodiment of the invention is shown. First, in step 200, place the optical disc 111 into the disc tray 110 of the recorder 100. Proceed to the step 202, determining if the best recording speed detection is performed. The recorder 100 gives a question command by using software as an interface and shows it on the display 150 for user's selection. If the user selects not to perform the best recording speed detection, continue to the step 204, in which the user selects the required recording speed from various recording speeds supported by the recorder 100 and the recorder 100 accordingly performs the OPC procedure. Afterward, in step 216, the recorder 100 records the optical disc 111 by the selected recording speed, and the process is then ended.

If the user selects to perform the best recording speed detection, proceed to the step 206, determining if the recording speed is selected by the user. The recorder 100 gives a question command by software and shows it on the display 150 for user's selection. If the user determines to select the recording speed by the recorder 100, continue to the step 208, performing the OPC procedure for each supporting recording speed by the recorder 100 to generate the corresponding recording quality index Qi. The recorder can then automatically select the recording speed according to the best recording quality index Qi. The method of generating recording quality index Qi will be described in detail in the following. Next, in step 216, the recorder 100 records the optical disc 111 according to the selected recording speed, and the process is then ended.

If the user selects to determine the required recording speed by himself/herself, proceed to the step 210, in which the recorder 100 performs the OPC procedure for each supported recording speed to generate the recording quality index Qi corresponding to each recording speed V. The processor 140 in the recorder 100 controls the spindle motor 120 to rotate the optical disc 111 at the required speed according to each recording speed V, and controls the optical pick up head 130 to perform the OPC procedure. In the OPC procedure, the optical pick up head 130 moves to different position relative to the optical disc 111 and performs recording detection on the optical disc 111 by various laser powers.

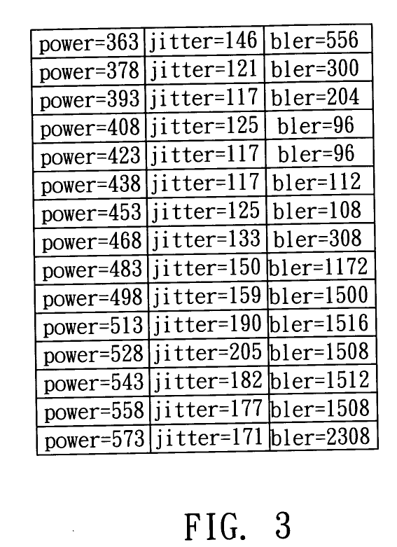

Referring to FIG. 3, a comparison diagram between the laser powers and the direct current jiggling value (jitter) and the block error rate (bier) generated thereby under a certain recording speed according to a preferred embodiment of the invention is shown. In terms of a CD disc, under a certain recording speed, there is a jitter and a bler corresponding to each laser power. The jitter is the difference between the time as the front edge and the rear edge of a specific pit or land is detected by time interval analysis, while the bler is the error rate of data decoded per second after data is recorded on the disc. The bler is called PI-Sum8 in terms of a DVD.

Therefore, the smaller the jitter and the bler are, the better disc recording quality is under a given laser power. As shown in FIG. 3, the jitter 117 and the bler 96, corresponding to the laser power 432 are the minimum under a certain recording speed, so the optimum recording power corresponding to the recording speed can be determined to be 423. Any one skilled in the prior art can easily find the basic definition and description related to the above-mentioned jitter and bler in industry specifications of various recorders or optical discs, so it is not required to give unnecessary details here.

The processor 140 can calculate the recording quality index Qi of each recording speed by the optimum jitter and the optimum bier corresponding to the optimum recording power. For example, the recording quality index Qi is equal to the sum of a jitter index and a bler index. The jitter index and the bler index are a normalized optimum jitter and a normalized optimum bier, respectively. That is, the initial optimum jitter and optimum bler are converted to index values capable of showing the rankings. Therefore, the lower the optimum jitter and the optimum bler are, the smaller the recording quality index Qi is, and accordingly the higher the recording quality of the optical disc 111 is.

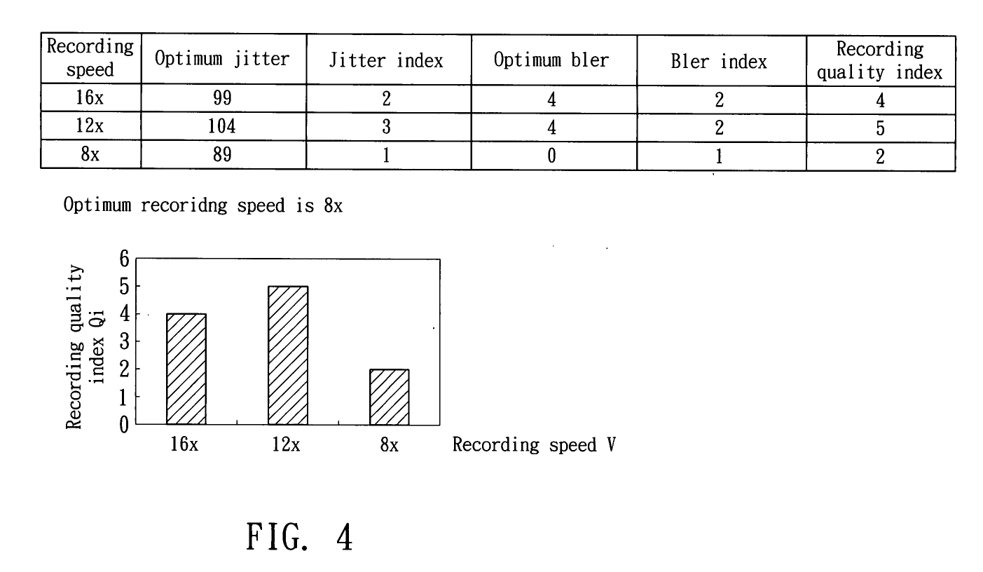

Continue to the step 212, in which the processor 140 shows the relation of each recording speed V and the corresponding optimum jitter, optimum bier, and recording quality index Qi on the display 150 for user's selection. As shown in FIG. 4, the relation of these values and indexes can be illustrated by a table or by a bar chart, or both. Afterward, in step 214, the user selects the required recording speed V according to these recording quality indexes Qi. For example, the user can select the lower recording speed 8×, and accordingly obtains the optimum recording quality, having the quality index Qi 2. Or the user can select the highest recording speed 16× and accordingly obtain not best but acceptable recording quality, having the quality index 4. Finally, in step 216, the recorder 100 records the optical disc 111 according to the recording speed V selected by the user.

As mentioned above, in the method of selecting recording speed of the invention, the recording quality index equal to the sum of the jitter index and the bler index is taken as an example. However, the method of the invention can also use only the jitter index or the bler index to represent the recording quality index, or use the error rate of data which cannot be decoded in the OPC procedure incorporated with the jitter index or the bler index to be the recording quality index. As long as the recoding quality index corresponding to each recording speed can be provided for selecting the optimum or user acceptable recording speed, all these will not be apart from the skill scope of the invention.

The method of selecting recording speed and recorder thereof according to the above-mentioned embodiment of the invention have the following advantages. The recorder can provide the disc recording quality index corresponding to each supported recording speed to the user for selecting the required recording speed. Or the user can determine not to perform the best recording speed detection and select the required recording speed directly. The user can even set the recorder to perform the best recording speed detection automatically and then manually select a recording speed to record the optical disc. Therefore, the user can select the recording speed corresponding to the optimum or acceptable recording quality. The invention not only provides the user with recording speed selection variety but also prevents the risk of recording failure by using the improper recording speed.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of selecting a recording speed, used in a recorder, the recorder providing a plurality of recording speeds for recording an optical disc, the method comprising:
(a) placing the optical disc into the recorder;
(b) performing an optimum power calibration (OPC) procedure for each recording speed in the recorder so as to obtain a corresponding recording quality index; and
(c) selecting the required recording speed from the recording speeds according to the recording quality indexes, and recording the optical disc by the selected recording speed to end the recording process.

2. The method according to claim 1, wherein the method comprises following steps between the step (a) and the step (b):
(a-1) determining if a best recording speed detection is performed, and if not, a user selects the required recording speed from the recording speeds and uses the recorder to record the optical disc by the selected recording speed to end the recording process.

3. The method according to claim 2, wherein the recorder gives a question command by using software as an interface to the user for determining if the recorder performs the best recording speed detection.

4. The method according to claim 3, wherein the question command is displayed on a display coupled to the recorder.

5. The method according to claim 2, wherein the method further comprises following step between the step (a-1) and the step (b):
(a-2) determining if the required recording speed is selected by the user, and if no, the recorder performs the OPC procedure under each recording speed and selects automatically the required recording speed from the recording speeds to record the optical disc to end the recording process.

6. The method according to claim 5, wherein the recorder gives a question command by using software as an interface to the user for determining if the required recording speed is selected by the user.

7. The method according to claim 6, wherein the question command is displayed on a display coupled to the recorder.

8. The method according to claim 5, wherein in the step (a-2), the step that the recorder selects automatically the required recording speed to record the optical disc further comprises:
(a-2-1) performing the OPC procedure according to each recording speed to generate the corresponding recording quality index; and
(a-2-2) selecting the required recording speed from the recording speeds according to the recording quality indexes to record the optical disc and end the recording process.

9. The method according to claim 8, wherein the step (a-2-1) further comprises:
(a-2-1-1) performing the OPC procedure for each recording speed to generate an optimum recording power of an optical pick up head; and
(a-2-1-2) obtaining the recording quality index for each recording speed according to an optimum block error rate (bler) and an optimum direct current jiggling value (jitter) corresponding to each optimum recording power.

10. The method according to claim 1, wherein the step (b) further comprised following steps of:
(b-1) performing the OPC procedure for each recording speed to generate an optimum recording power of an optical pick up head; and
(b-2) obtaining the recording quality index for each recording speed according to an optimum block error rate (bler) and an optimum direct current jiggling value (jitter) corresponding to each recording power.

11. The method according to claim 10, wherein the bler is a value of PI-Sum8.

12. The method according to claim 10, wherein the recording quality index is the sum of a jitter index and a bler index which are the normalized optimum jitter and the optimum bler, respectively.

13. The method according to claim 1, wherein in the step (c), the required recording speed is selected by a user according to the recording quality indexes.

14. The method according to claim 1, wherein in the step (c), the required recording speed is selected by the recorder according to the recording quality indexes.

15. A recorder, capable of providing a plurality of recording speeds for recording an optical disc, the recorder comprising:
an optical pick up head, for recording the optical disc; and
a processor, for controlling the optical pick up head to perform an optimum power calibration (OPC) procedure for each recording speed and providing a recording quality index accordingly;
wherein the recorder selects the required recording speed from the recording speeds according to the recording quality indexes corresponding to the recording speeds and records the optical disc accordingly.

16. The recorder according to claim 15, wherein the processor uses the OPC procedure to generate an optimum recording power of the optical pick up head corresponding to each recording speed.

17. The recorder according to claim 16, wherein the recording quality index of the optical disc corresponding to each recording speed is determined by an optimum block error rate (bler) and an optimum direct current jiggling value (jitter) corresponding to the optimum recording power.

18. The recorder according to claim 17, wherein the recording quality index is the sum of a jitter index and a bler index which are the normalized optimum jitter and the optimum bier, respectively.

19. The recorder according to claim 15, wherein a display is coupled to the recorder for displaying the recording speeds and the corresponding recording quality indexes.

20. The recorder according to claim 15, wherein the optical disc is a CD, a DVD, or a Blu-ray disc (BD).

21. The method according to claim 9, wherein the bler is a value of PI-Sum8.

22. The method according to claim 9, wherein the recording quality index is the sum of a jitter index and a bler index which are the normalized optimum jitter and the optimum bier, respectively.
